(19) United States
(12) Patent Application Publication
(10) Pub. No.: US 2026/0326677 A1
(43) Pub. Date: Oct. 22, 2026

(54) VEHICLE MOUNTED TRANSPORTATION RACK

(71) Applicant: Shingleback Off Road Pty Ltd, Beechworth (AU)

(72) Inventor: Andrew Taylor, Beechworth (AU)

(21) Appl. No.: 19/117,565

(22) PCT Filed: Oct. 3, 2023
(86) PCT No.: PCT/AU2023/050951

§ 371 Date: Apr. 1, 2025

(30) Foreign Application Priority Data
Oct. 3, 2022 (AU) 2022902855

(51) Int. Cl. B60R 9/06; B60D 1/52

(52) U.S. Cl. CPC B60R 9/06; B60D 1/52

(57) ABSTRACT

The present invention provides a rack for transporting bicycles and/or other items on a vehicle such as a car or truck. The rack has a mechanism that allows for tilting of a carrier portion of the rack relative to the vehicle, which enables easier loading and unloading of the rack and also easier access to the vehicle while the rack is mounted thereto. The tilting mechanism has a latch that is user operable by hand or foot for tilting the carrier, and the latch automatically re-engages when the carrier is returned upright. The mechanism employs relatively few moving parts, and is simple and robust in design and construction yet easy to operate by a user in the field.

### CROSS-REFERENCE TO RELATED APPLICATIONS

The present application is a U.S. National Phase Entry under 35 U.S.C. § 371 of International PCT Application No. PCT/AU2023/050951 having an international filing date of Oct. 3, 2023, which claims priority to Australian Application No. 2022902855, filed Oct. 3, 2022. Benefit of the filing date of each of these prior applications is hereby claimed. Each of these applications is hereby incorporated by reference in its entirety.

### FIELD OF THE INVENTION

This invention relates to a rack or carrier, and components therefor, adapted for mounting to a motor vehicle such as a car or truck, or a towed vehicle such as a trailer or caravan. In embodiments of the invention the rack is designed for transporting one or more bicycles, although the rack may alternatively be adapted to carry other items, tools, or equipment.

### BACKGROUND

Vertical bike racks are a form of transportation carrier for bicycles, including electric bicycles (‘e-bikes’), in which the bikes are supported on the rack in a generally vertical orientation for transport. A vertical bike rack is typically mounted on the rear of a motor vehicle such as a car or truck, by attachment to the vehicle towbar hitch (trailer hitch).

When the bike rack is configured for transportation (i.e. in a vertical orientation), persons of short stature may find it difficult to load and unload bicycles from the rack. Moreover, the bike rack and bicycles carried thereon may hinder or obstruct access to the rear facilities of the vehicle such as the tailgate or rear door. For these reasons it may be beneficial for the vertical bike rack to be capable of tilting or pivoting away from the vehicle, without removing the rack from the vehicle and without removing any bicycles from the rack.

In this context, there is a need for an improved vehicle-mounted rack that addresses one or more of the problems outlined above or that least provides the public with a useful alternative.

### SUMMARY OF THE INVENTION

The present invention provides a rack for transporting bicycles and/or other items on a vehicle such as a car or truck, for instance. The invention is also concerned with a mechanism for use in such a rack that allows for tilting of a carrier portion of the rack relative to the vehicle, which enables easier loading and unloading of the rack and also easier access to the vehicle while the rack is mounted thereto. The tilting mechanism according to embodiments of the invention employs relatively few moving parts, and is simple and robust in design and construction yet easy to operate by a user in the field.

According to one aspect of the present invention, there is provided a rack comprising: a vehicle-coupling portion adapted for mounting to a vehicle for transportation; a carrier portion on which one or more items can be loaded, the carrier portion being supported by the vehicle-coupling portion; and a linkage for pivotal coupling between the carrier portion and the vehicle-coupling portion, the linkage being configured: to allow the carrier portion to pivot between a substantially upright position and a lowered position in which the carrier portion is tilted away from the vehicle when the vehicle-coupling portion is mounted to the vehicle; and automatically latch the carrier portion into place when it is raised by the user from the lowered position to the upright position.

The linkage preferably includes a base portion fixed to the vehicle-coupling portion, the base portion supporting the carrier portion for pivotal action between the upright position and the lowered position, and a latch portion coupled to the carrier portion, the latch portion having a latch formation that engages with a corresponding formation on the base portion. The latch portion may be pivotally mounted to the carrier portion, wherein the linkage includes a resilient biasing member arranged to act between the latch portion and the carrier portion to bias the latch portion into a pivotal orientation to maintain the engagement between the latch formation and the corresponding formation on the base portion while the carrier is in the upright position. The latch portion may include a latch release member projecting therefrom, the latch release member being adapted for manipulation by the user to pivot the latch portion against the force of the resilient biasing member in order to disengage the latch and allow the carrier portion to be lowered.

The base portion may be provided with a tilt limit member against which a surface of the carrier portion can rest when in the lowered position. The tilt limit member may be moveable or removable by the user so as to permit the carrier portion to be further pivoted beyond the lowered position to a horizontal position.

Preferably the latch member and the base member have corresponding safety formations that align when the carrier is in the upright position and the latch is engaged, and wherein a safety member is provided for engagement with the corresponding safety formations when so aligned, the safety member acting to prevent the latch member from disengaging with the base member.

The rack is a vehicle-mountable rack. For example, the rack may be a bike rack onto which one or more bicycles can be loaded. The bicycle may be a mountain bicycle, road bicycle, hybrid bicycle, an e-bicycle, kids bicycle, or a fat bicycle. In other embodiments, the rack may be a utility rack onto which one or more tools or equipment can be loaded.

The carrier portion may be pivotable relative to the vehicle-coupling portion between the substantially upright position and one or more lowered positions. The carrier in the substantially upright position may be tilted slightly forward towards the vehicle. Preferably, the carrier in the substantially upright position is between about 80° to 100° to the ground surface.

An angle between the carrier portion in the lowered position and the carrier portion in the upright position is up to about 70°. Preferably, the angle is up to about 60°. Further preferably, the angle is up to about 50°. With removal of the tilt limit member, the carrier portion may also be pivoted further to a substantially horizontal position, whereupon the carrier portion can function as a bicycle stand.

It will be appreciated that the broad forms of the invention and their respective features can be used in conjunction and/or independently, and reference to separate broad forms is not intended to be limiting. Furthermore, it will be appreciated that features of the method can be performed using the system or apparatus and that features of the system or apparatus can be implemented using the method.

### BRIEF DESCRIPTION OF THE DRAWINGS

An embodiment of the invention is described in greater detail hereinbelow, by way of non-limiting example only, with reference to the accompanying drawings, in which:

FIGS. 1A and 1B are side views of a rack according to an embodiment of the present invention, mounted on a vehicle and seen in upright and tilted positions, respectively;

FIG. 2 is a side view of a vehicle coupling portion of the rack, including a carrier tilt mechanism;

FIG. 3 is an angled reverse side view of the vehicle coupling portion of the rack, including carrier tilt mechanism;

FIG. 4 shows disassembled components of the vehicle coupling portion and carrier tilt mechanism;

FIGS. 5A and 5B show, in isolation, a latch member that forms part of the carrier tilt mechanism;

FIG. 6 shows the latch member assembled with a support member of the carrier, in isolation from the rest of the rack;

FIGS. 7, 8 and 9 illustrate operation of the latch mechanism in a rack according to an embodiment of the invention;

FIG. 10 shows the rack according to an embodiment of the invention, with the carrier in a horizontal position for use as a bike stand;

FIGS. 11 and 12 show the carrier tilt mechanism according to embodiments of the invention, illustrating variations of the safety pin arrangement;

FIGS. 13A and 13B show a rack according to an embodiment of the invention, mounted on a vehicle and loaded with bicycles;

FIGS. 14 and 15 are perspective views of a rack according to an embodiment of the invention;

FIGS. 16A-16C are side views of the carrier tilt mechanism according to an embodiment of the invention, illustrating the tilting and latching action;

FIGS. 17A-17C are perspective views of the carrier tilt mechanism corresponding to FIGS. 16A-16C, respectively; and

FIGS. 18A-18C, are further perspective views of the carrier tilt mechanism corresponding to FIGS. 16A-16C, respectively.

### DETAILED DESCRIPTION

Various forms of vertical bike racks are described and illustrated in the specification of international patent application no. PCT/AU2021/051081 and the specification of Australian provisional patent application no. 2020903354, the contents of which are hereby incorporated by reference in their entirety.

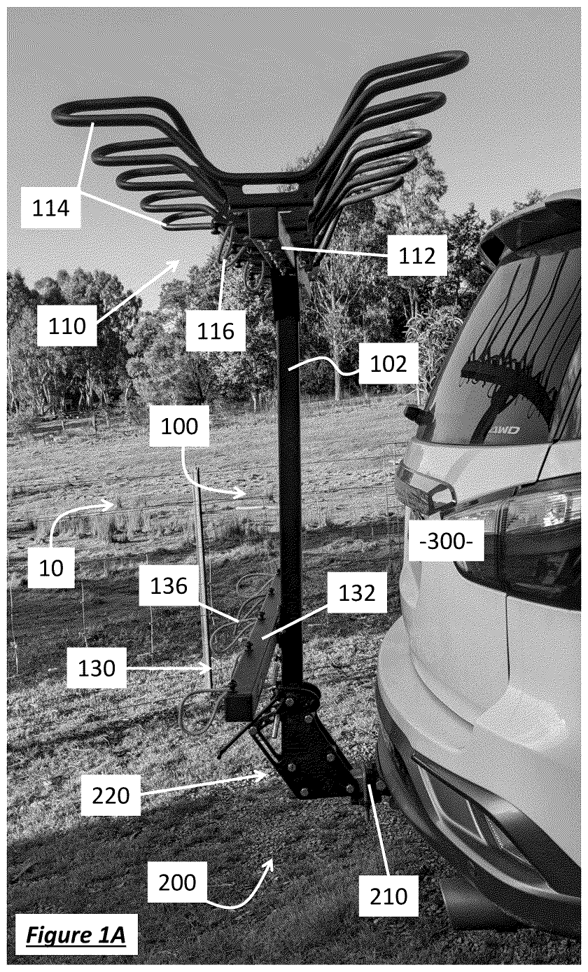

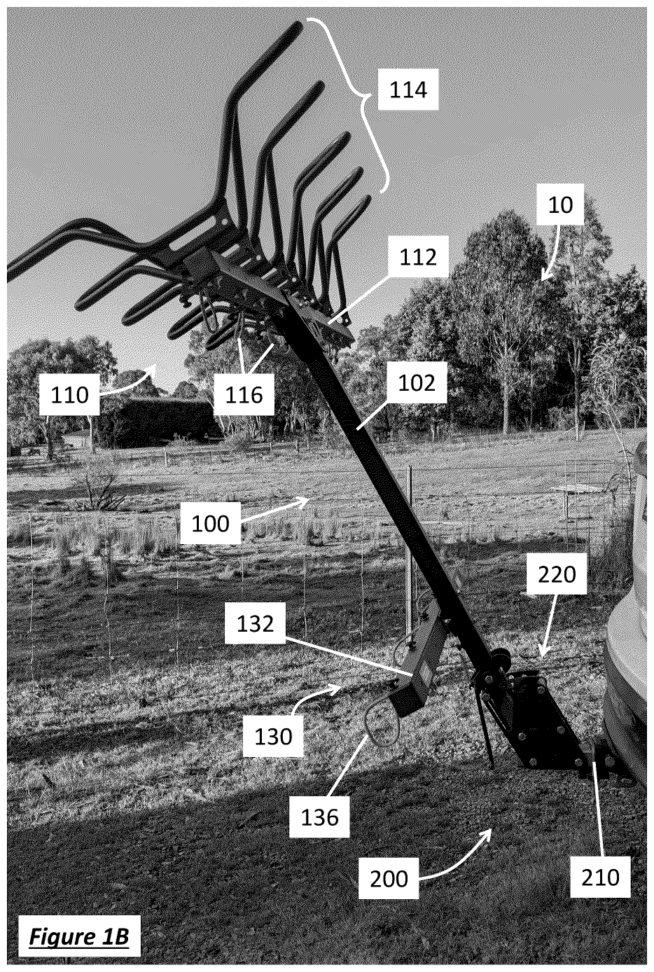

FIGS. 1A and 1B show a rack 10 according to an embodiment of the present invention, mounted to a motor vehicle 300. In various configurations, the rack may be a bike rack onto which one or more bikes can be loaded, or alternatively a utility rack onto which one or more items, tools or equipment can be loaded such as snowboards, skis, fishing rods, a kayak, a storage trunk, tool box, shovels, rake, or other tools or equipment.

The rack 10 has a carrier portion 100 on which mounting assemblies can be attached, to support one or more bicycles or other items to be transported. The rack 10 also has a vehicle-coupling portion 200 for coupling the rack 10 to a vehicle 300. In the situation where bicycles are to be mounted to the rack 10, the bicycle may be a mountain bicycle, road bicycle, hybrid bicycle, e-bicycle, kids bicycle, or a fat bicycle.

In preferred embodiments, the vehicle-coupling portion 200 has a vehicle tow-hitch coupling portion 210 that is adapted to engage with or mount to a tow-hitch of the vehicle. The vehicle-coupling portion 200 includes a carrier tilt mechanism 220 that supports the carrier portion 100 of the rack 10 and interconnects the carrier portion with the vehicle tow-hitch coupling 210. The carrier tilt mechanism 220 enables the carrier portion 100 to be selectively tilted relative to the vehicle tow-hitch coupling 210 (and thus tilted with respect to the vehicle 300 when the rack is mounted thereon). FIG. 1A shows the carrier portion 100 in an upright (vertical) position, while FIG. 1B shows the carrier portion 100 in a lowered (tilted) position, angled away from the rear of the vehicle. Several intermediate tilted positions between the upright position and the lowered position are also possible.

When in the ‘upright position’ the carrier portion 100 may be at about 80° to 100° to the ground surface, in use. It may be preferred that, when in the upright position, the carrier portion is tilted slightly forward towards the vehicle. In embodiments of the invention, a tilting range of the carrier portion 100 from the upright position to the lowered position is up to about 70°. In other examples, the pivoting range of the carrier portion may be up to about 60° or up to about 50°. In the lowered position, a user can more easily mount or dismount a bicycle or other item with respect to the carrier portion 100. In addition, with the carrier portion in the lowered position, the user is able to more easily access the rear of the vehicle 300. In preferred embodiments of the rack 10 of the present invention, the carrier portion 100 can be adjusted from the upright position to the lowered position, and vice-versa, without having to unload any bicycles or other items from the carrier portion.

The carrier portion 100 has an elongate support member 102 on which upper and lower mounting portions 110, 130 are located. Each mounting assembly has an elongate body that is substantially transverse to the elongate support member. In particular, an axis through the elongate support member is substantially perpendicular to an axis through the elongate body of each mounting assembly. The upper and lower mounting assemblies are substantially parallel with each other. In the embodiment of the rack 10 as illustrated, the carrier portion has an upper mounting assembly on which a front wheel of a bicycle is mountable and a lower mounting assembly on which a rear wheel of a bicycle is mountable.

The upper mounting assembly 110 has a transversely extending upper crossbar 112 attached at or near the top of the support member making a generally T-shaped formation. The top of the upper crossbar 112 supports a plurality of hoop portions (wheel-receiving portions) 114, each for receiving a respective front bicycle wheel. In the embodiment illustrated, five hoop portions are provided, spaced along the length of the upper crossbar 112. A different number of hoop portions may be provided, if desired, although if the number is greater than a longer crossbar may be required in order to accommodate them.

When a bicycle front wheel is located in a respective one of the hoop portions 114, the front wheel would be retained in a generally vertically tilted position and prevented from any sideward movements. By locating the tires in a vertically tilted position, bikes can be closely nested such that handlebars of adjacent bikes do not clash with each other. This is illustrated in FIGS. 13A and 13B, for example, which shows the rack 10 according to an embodiment of the invention mounted on a vehicle 300 and loaded with a plurality of bikes 400 of various sizes. The front wheels of the bikes are angled while they are supported and held in the hoop portions 114 of the carrier 100. FIG. 13A shows the rack 10 with the carrier in the upright position ready for transportation. FIG. 13B shows the rack 10, still loaded with the bicycles 400, but with the carrier 100 in its tilted position which allows the vertically opening rear door 302 of the vehicle to open for access to the rear compartment.

Each hoop portion 114 for receiving a front wheel of a bicycle includes a securing cord 116 for securing the wheel to the respective hoop portion and a pair of spaced apart mounting brackets for mounting the hoop portion to the upper crossbar. The securing cord may be a bungee cord or a shock cord for example. In other examples, the securing cord may be replaced with a rope portion, cable portion, or strap portion. For example, the cord portion may be replaced with a stretch lock strap or a cam buckle.

Each hoop portion 114 is adjustable relative to the upper crossbar 112 to which it is mounted. For example, the hoop portion can be adjusted forward or backward, or angled relative to the upper crossbar, which helps to accommodate a variety of different kinds and sizes of bicycles. The ways in which the hoop portions can be adjustably mounted in relation to the crossbar are described in the aforementioned international patent specification and are also applicable to embodiments of this invention.

The lower mounting portion 130 for the carrier portion 100 of the rack 10 is attached toward the bottom of the support member 102. The rear wheel of a bicycle mounted to the rack is locatable on the lower mounting portion 130, in use. The lower mounting portion 130 comprises a lower crossbar 132 that may have a plurality of spaced apart recesses each for receiving a rear wheel of a respective one of the bicycles to be mounted to the carrier portion 100. The lower crossbar additionally has a plurality of lower securing cords 136 each for securing the rear wheel of a bicycle supported in a respective hoop portion of the rack.

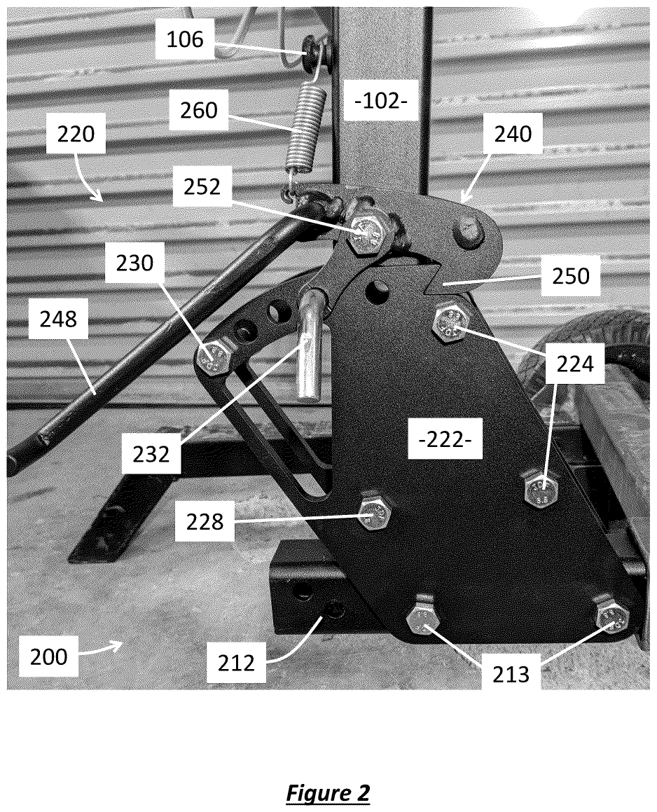

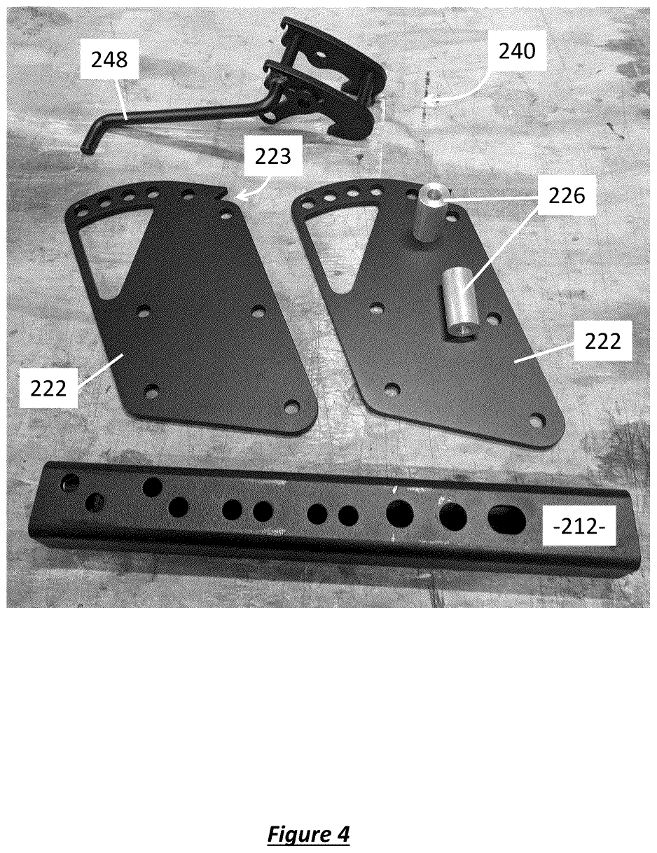

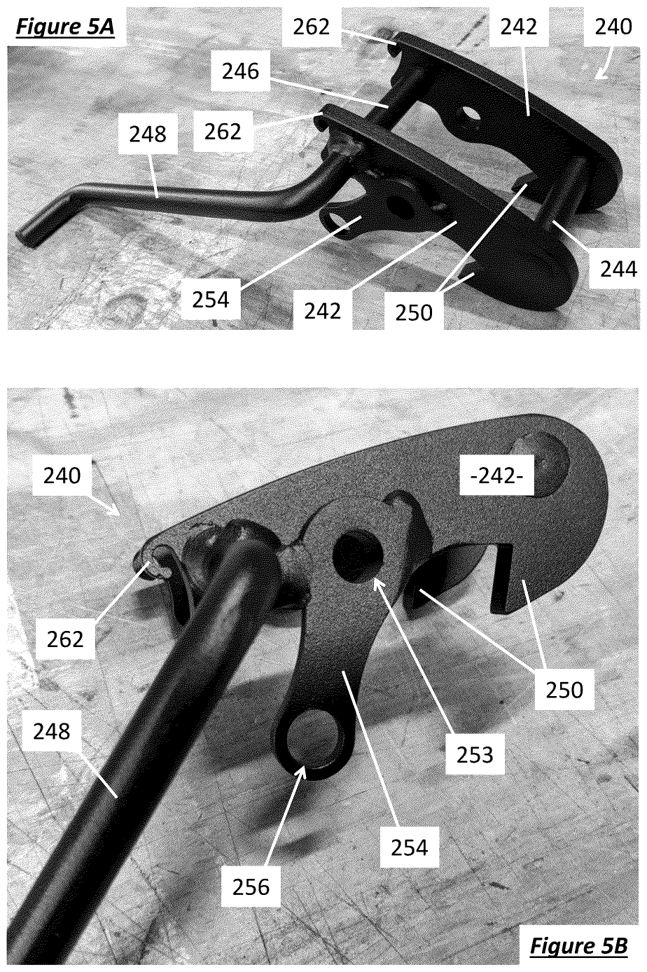

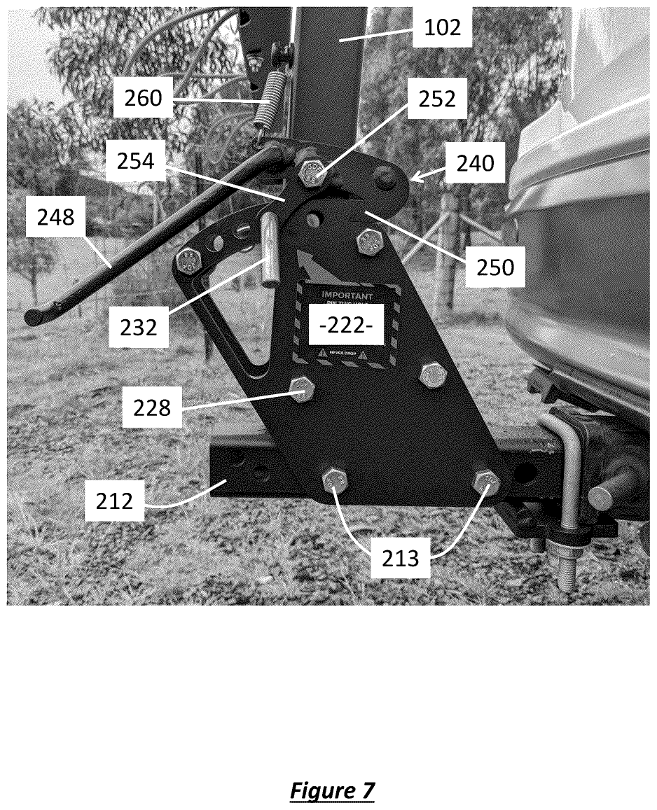

The vehicle-coupling portion 200 includes the carrier tilt mechanism 220 that supports the carrier portion 100 of the rack 10 and interconnects the carrier portion with the vehicle tow-hitch coupling 210. When the rack is in its upright position (e.g. as seen in FIG. 1A), the carrier tilt mechanism can be user operated by hand or foot to release a latch to allow the carrier to be lowered into its tilted position (e.g. as seen in FIG. 1B) for loading or unloading of bikes or to access the vehicle rear facilities. From the tilted position of the rack, the carrier can simply be pushed back into a vertical orientation, whereupon the latch automatically engages to maintain the carrier upright. The carrier tilt mechanism, its components and features are shown in FIGS. 2 to 6 and described hereinbelow. FIGS. 7, 8 and 9 illustrate operation of the tilt mechanism to lower the rack carrier from the upright position to the tilted position.

The vehicle tow-hitch coupling 210 is adapted for engaging a tow-hitch of the vehicle to thereby couple the rack 10 to the vehicle. The tow-hitch coupling 210 is, in use, attached to the vehicle to resist lateral and vertical movements of the rack relative to the vehicle. The tow-hitch coupling 210 has a square-section tubular base member 212, extending rearwardly from its connection in the vehicle tow-hitch, to which the carrier tilt mechanism 220 is fastened by way of bolts 213.

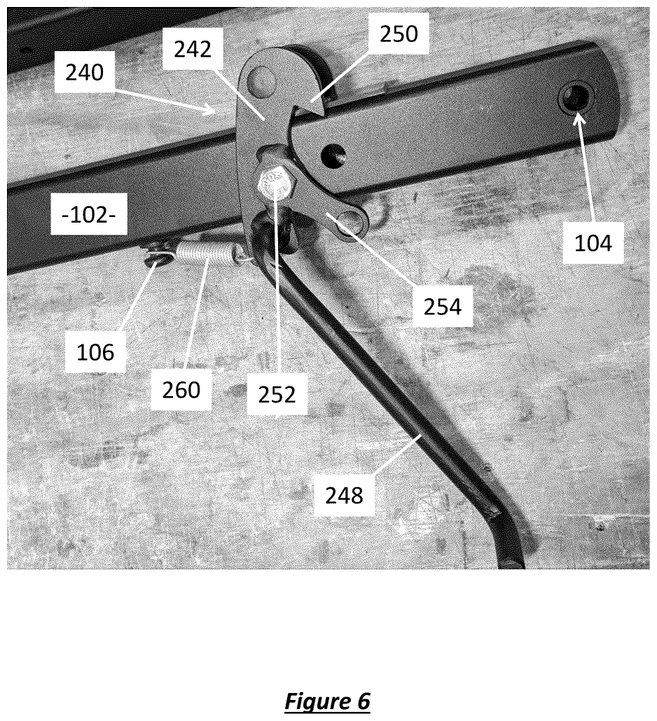

The carrier tilt mechanism 220 has a pair of gusset plates 222 that are fastened to respective opposite lateral sides of the base member 212 by means of the base bolts 213. The space between the two gusset plates allows the lower end of the support member 102 to fit therebetween, since the support member 102 has a similar width as the base member 212. The support member 102 has a through-hole 104 near its bottom end (FIG. 6). A carrier pivot bolt 228 extends through the two gusset plates 222 and the hole 104 in the support member, forming a coupling which allows the support member to pivot relative to the gusset plates. This arrangement supports the carrier portion 100 while allowing it to pivot forward and backward relative to the vehicle coupling portion 200.

The two gusset plates 222 are also fastened to one another by way of spacing bolts 224, which pass through spacing tubes 226 positioned between the gusset plates. When mounted on the base member 212 the gusset plates 222 project upwardly and have an arcuate upper edge with radius centered on the carrier pivot bolt 228. The arcuate upper edges of the gusset plates extend rearwardly from a forward facing notch 223, and the gusset plates are fastened together at the rear by a limit bolt 230. The pivoting motion of the support member 102 about the pivot bolt 228 is thus restricted by the upper spacing bolt 224 in the forward direction and the limit bolt 230 in the rearward direction. In other words, the limit bolt 230 bearing against a surface of the support member 102 defines the maximum extent to which the carrier can tilt.

A latch member 240 is pivotally coupled to the support member just above the upper edge of the gusset plates 222 by way of latch pivot bolt 252. The latch member 240 is formed from two latch plates 242 which are fastened together by front and rear spacer bars 244, 246. The spacing between the latch plates 242 corresponds to the spacing between the gusset plates 222. Each latch plate 242 has a latch tooth 250 that projects downwardly and to the rear such that, when the carrier is in its upright position, the latch tooth 250 engages in the latching notch 223 of the corresponding gusset plate. One side of the latch member 240 is provided with a latch actuator handle 248 that extends downwardly and to the rear, and is attached to the latch member rearwardly of the latch pivot bolt hole 253. The rear of the latch member 240 has a spring hook 262 on each of the latch plates, which allows the end of one or more bias springs 260 to be coupled thereto. The other end(s) of the bias spring(s) are coupled to a bias spring fastener 106 provided on the support member above the latch member 240.

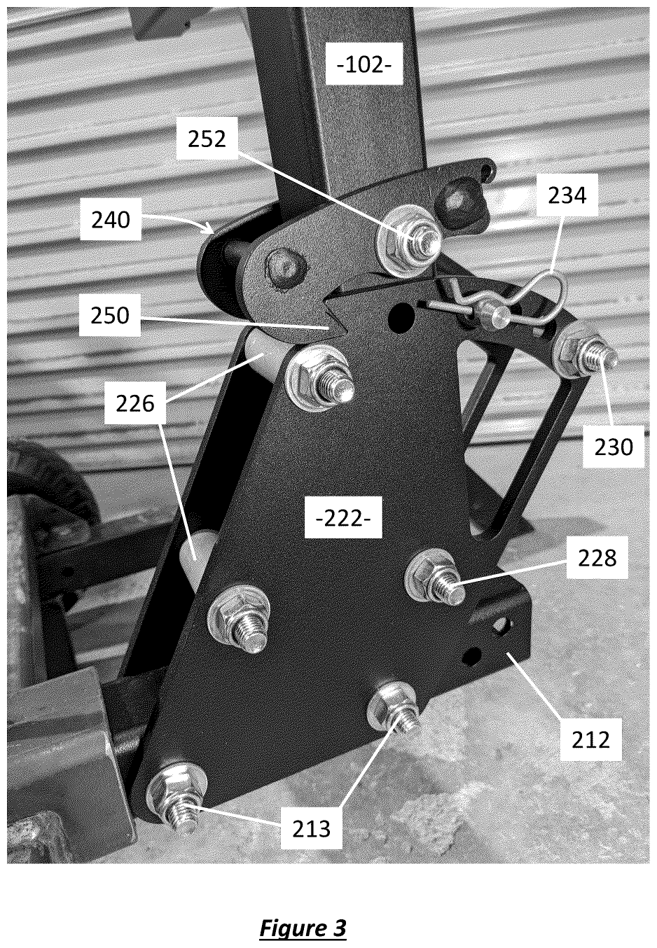

One of the latch plates 242 additionally has a safety stop projection 254 that extends downwardly adjacent the corresponding the gusset plate 222. The lower end of the safety stop projection 254 has a safety pin hole 256 therethrough. When the carrier 100 is in its upright position and the latch teeth 250 are engaged in the corresponding gusset plate notches 223, the safety pin hole 256 aligns with corresponding holes in the top of the gusset plates to allow a safety pin 232 to be received therethrough. The safety pin 232 thereby prevents rotation of the latch member 240, such that the mechanism cannot be unlatched, and the carrier cannot be tilted from its upright position. The end of the safety pin can be secured with an R-clip 234 (FIG. 3) to prevent the safety pin from falling out or being inadvertently dislodged. A split pin or other form of securing device may be used in place of the R-clip if desired.

FIG. 7 shows the rack 10 according to an embodiment of the invention with the carrier held in its upright position by the carrier tilt mechanism 220. The latch tooth 250 of the latch member 240 is engaged in the latching notch 223 of the corresponding gusset plate 222. Moreover, the latch tooth is unable to disengage because the safety pin 232 is inserted through the safety stop projection 254 and gusset plates 222, which prevents the latch member 240 from rotating about the latch pivot bolt 252. This is the configuration in which the rack is suitable for transportation on the vehicle to which it is mounted, whether it is empty or loaded with one or more bicycles.

In order to lower the carrier to its tilted position for loading or unloading, or for access to the rear of the vehicle, it is first necessary to remove the safety pin 232, which may first involve removing the R-clip 234. Even without the safety pin, the latch member is held in place with the latch tooth 250 engaged in the latching notch 223 by force of the bias spring 260 acting between the spring hook 262 and the fastener 106 on the carrier support member. With the safety pin removed, as seen in FIG. 8, the user can press forward on the distal end of the latch actuator handle 248, either by hand or by foot, so as to rotate the latch member 240 about the latch pivot bolt 252 relative to the support member 102 against the extension force of the bias spring 260. This raises the latch tooth 250 out from the latching notch 223 and above the top edge of the gusset plate 222. Once the latch is thus disengaged, the user can allow the carrier to lower and tilt toward the rear.

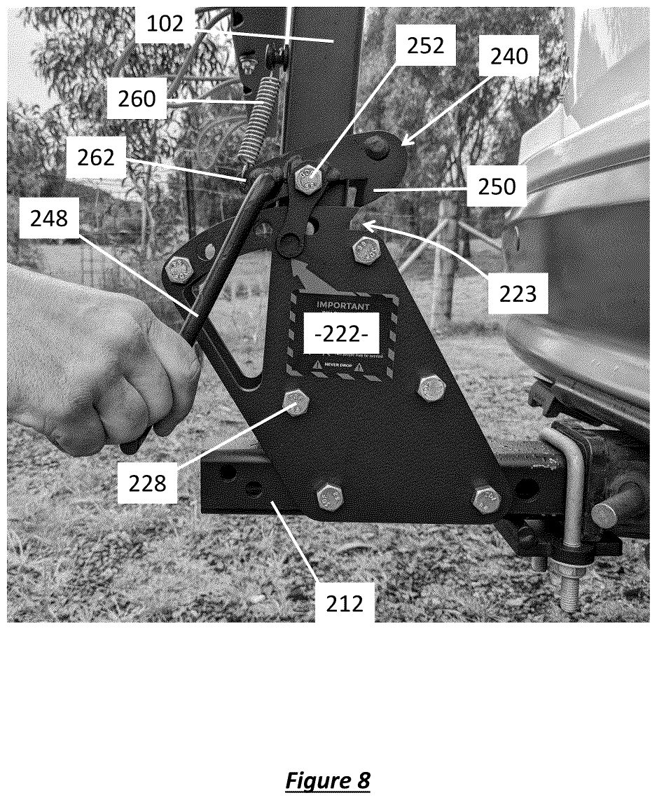

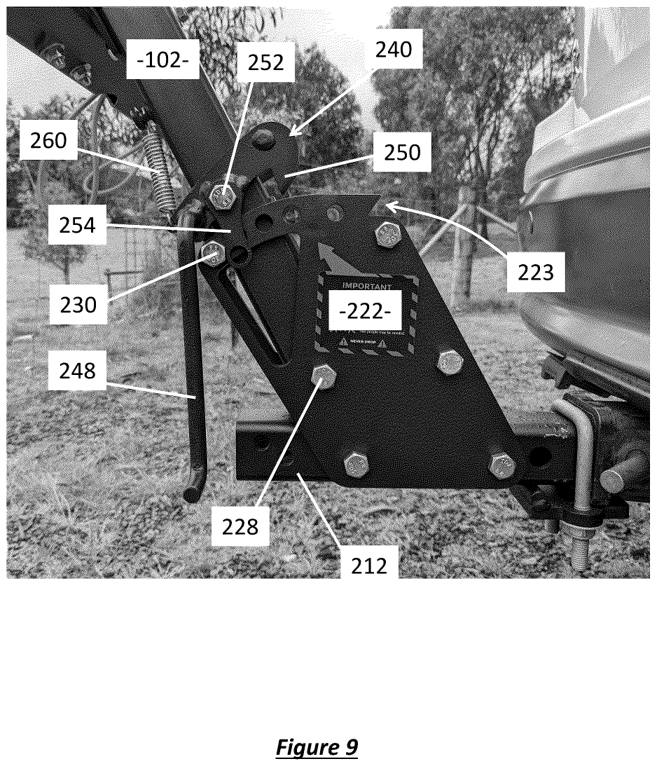

As the carrier support member 102 lowers toward its tilt limit, the safety stop projection 254 engages with the head of the limit bolt 230, further rotating the latch member 240 against extension force of the bias spring 260, as seen in FIG. 9. This provides a cushioning effect before the support member itself engages with the limit bolt when the carrier reaches its tilt limit.

In order to raise the carrier 100 from the tilted position to the upright position, the user need simply push forward on the carrier, for instance by pressing forward on the support member 102. This will cause the carrier to pivot about the carrier pivot bolt 228 toward the upright position. When the carrier reaches its upright position, the latch tooth will clear the end of the arcuate upper surface of the gusset plate, and drop down to engage in the latching notch 223, assisted by force of the bias spring 260. Thus, simply by returning the carrier to the upright position, the latch mechanism will re-engage without further action by the user. Nevertheless, it is recommended that the safety pin 232 be inserted and secured before the rack is transported on the vehicle.

While in ordinary use as a transportation rack, the angle to which the carrier can be lowered is restricted by the limit bolt 230. However, if the limit bolt 230 is removed it is possible to further pivot the carrier down to a substantially horizontal position, where ends of the hoop portions 114 rest on the ground. This permits the rack to function as a bike stand, as illustrated in FIG. 10, as the hoop portions 114 are then oriented and located in such a way as to accept the wheel of one or more bicycles 400 in a standing arrangement. Moreover, with the carrier of the rack fully lowered in this way, the user is afforded greater access to the rear of the vehicle 300, and even a horizontally opening vehicle rear door 303 can be opened without the rack having to be dismounted from the tow hitch. In the interests of user safety, it will be appreciated that the rack should be unloaded before removing the limit bolt and lowering the carrier to the horizontal position.

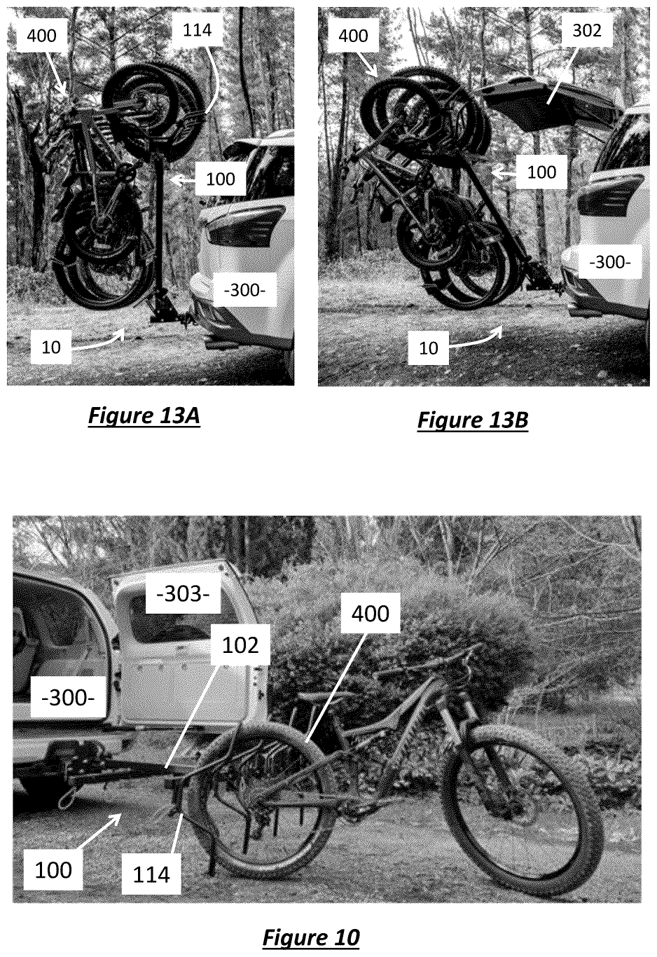

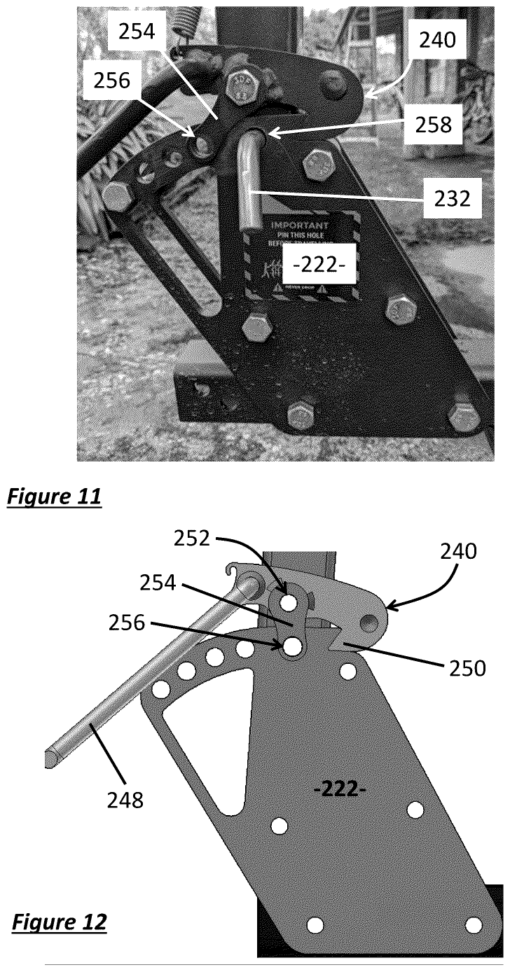

FIGS. 11 and 12 show the carrier tilt mechanism according to embodiments of the invention, illustrating variations in use of the safety pin to secure the carrier in the upright position during transport and the like. In the embodiment of the rack as described above, the safety pin 232 is inserted through the safety pin hole 256 provided in the safety stop projection 254, where the safety pin hole is aligned with corresponding apertures formed in the gusset plates that are located to the rear of the support member 102. In that arrangement, the support member is captured between the upper spacing bolt 226 and the safety pin 232, and the latch member 240 is held in its latch position by the safety pin. As seen in FIG. 11, it is also possible to insert the safety pin 232 through an alternative safety pin hole 258 that extends through both gusset plates 222 and through the walls of the support member 102. This arrangement positively locks the support member 102 and the gusset plates 222 together by means of the safety pin. However, if this location of the safety pin is to be employed, it is preferred that the latch member have a modified form of safety tab 254, as illustrated in FIG. 12 for example. In this modification, the safety tab 254 projects downwardly but not to the rear, such that the safety pin hole 256 aligns with the hole 258 when the carrier is upright and the latch is engaged. In this way, the safety pin can engage through and lock together the gusset plates, latch member and support member all at once.

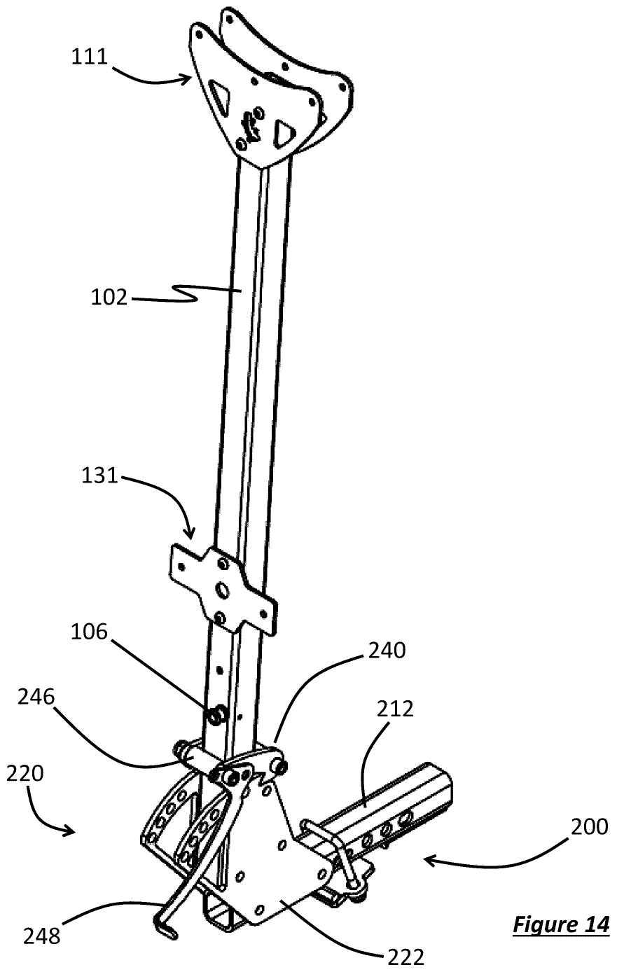

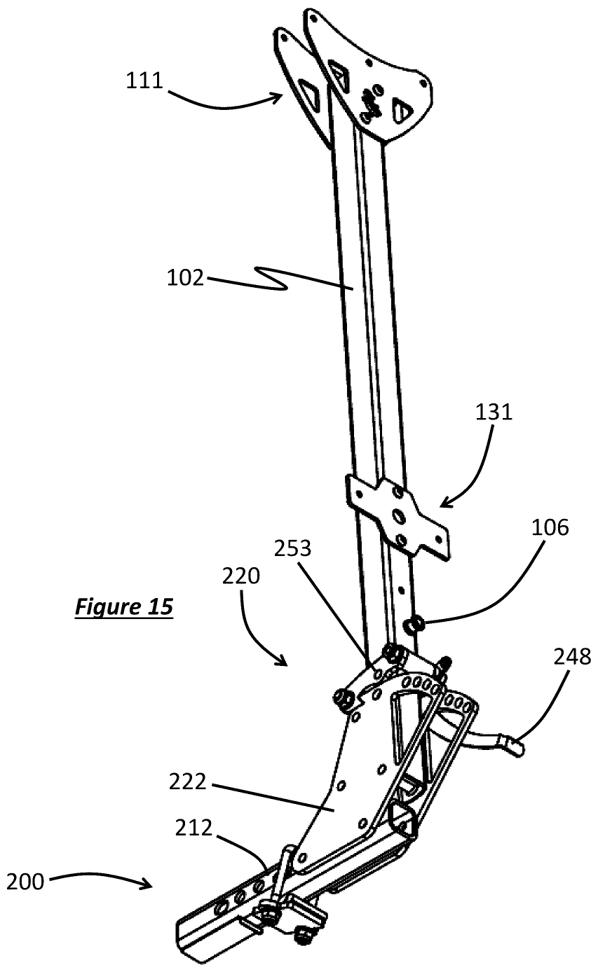

FIGS. 14 and 15 are upper and lower perspective views of a rack according to an embodiment of the invention, some components not shown for clarity of view. The support member 102 has upper and lower mounting plates 111, 131 attached thereto, onto which may be mounted the upper and lower mounting portions 110, 130, respectively.

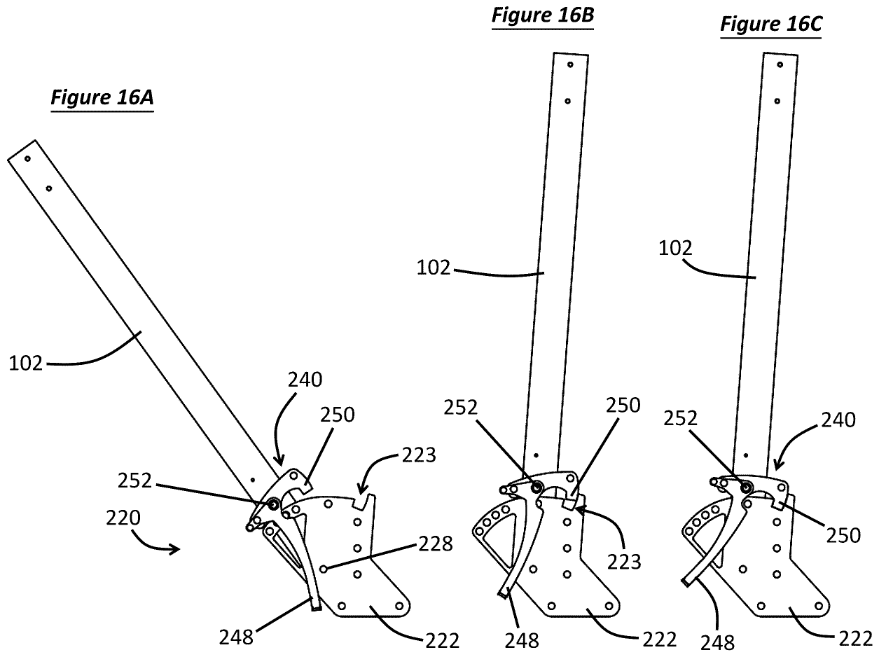

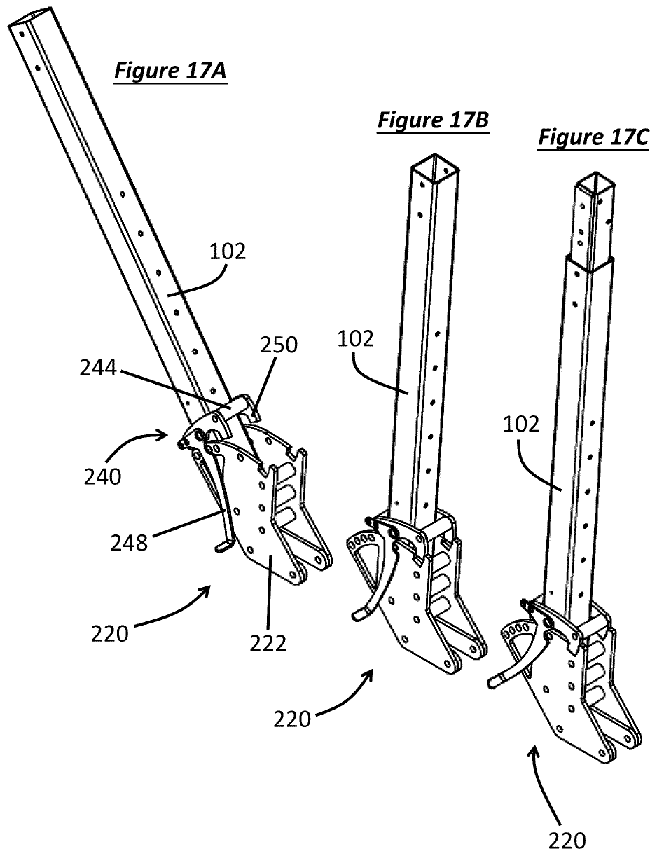

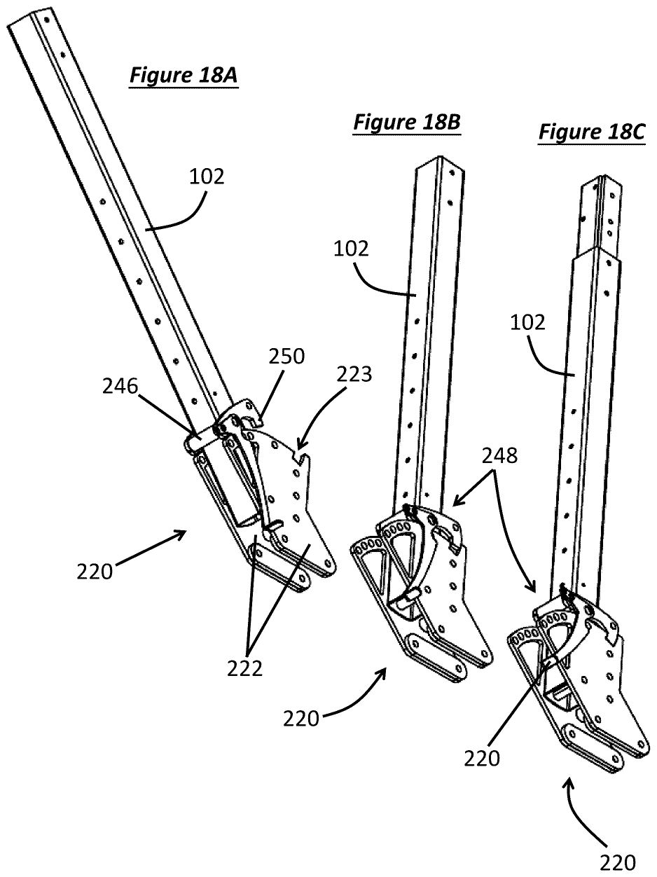

FIGS. 16A-16C are side views of the carrier tilt mechanism according to an embodiment of the invention, illustrating the tilting and latching action. FIGS. 17A-17C are perspective views of the carrier tilt mechanism corresponding to FIGS. 16A-16C, respectively, as are FIGS. 18A-18C. In FIGS. 16C, 17C and 18C, the support member 102 is upright and the tooth 250 of the latching member 240 is engaged in the latching notch 223. In FIGS. 16B, 17B and 18B, the latch tooth 250 has been disengaged from the latching notch 223, by pivoting the latching member 240 about the latch pivot 252 by means of the handle 248. In FIGS. 16A, 17A and 18A, with the latch disengaged, the support member 102 is shown angled to its lowered position. In the embodiment shown in FIGS. 16A-18C, the design of the latch tooth 250 and latching notch 223 is slightly different than previously described, insofar as the tooth 250 has a flat end rather than a pointed end, with the latching notch 223 correspondingly shaped to suit the squared-end tooth profile.

Although the described embodiment does not include springs and/or dampening struts for assisting with raising/lowering of the carrier, it will be appreciated that such mechanisms may be included, for example in the manner described in the aforementioned international patent specification.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above” and “below” and the like are used as words of convenience to provide reference points and are not to be construed as limiting terms.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### COMPENDIUM OF REFERENCE NUMERALS

10 rack
100 carrier portion
102 support member
104 carrier pivot hole
106 bias spring fastener
110 upper mounting portion
111 upper mounting plate
112 upper crossbar
114 hoop portions (wheel-receiving portions)
116 upper securing cords
130 lower mounting portion
131 lower mounting plate
132 lower crossbar
136 lower securing cords
200 vehicle-coupling portion
210 vehicle tow-hitch coupling
212 base member
213 fastening bolts
220 carrier tilt mechanism
222 gusset plates
223 latching notch
224 spacing bolts
226 spacing tubes
228 carrier pivot bolt
230 limit bolt
232 safety pin
234 split pin
240 latch member
242 latch plates
244 front spacer bar
246 rear spacer bar
248 latch actuator handle
250 latch tooth
252 latch pivot bolt
253 latch pivot bolt hole
254 safety stop projection
256 safety pin hole
258 alternative safety pin hole
260 bias spring
262 spring hook
300 vehicle
400 bicycle

1. A rack comprising:
a vehicle-coupling portion configured to be mountable to a vehicle for transportation;
a carrier portion configured to support one or more items loaded thereon, the carrier portion being supported by the vehicle-coupling portion; and
a linkage configured to pivotally couple the carrier portion and the vehicle-coupling portion, the linkage being configured:
to allow the carrier portion to pivot between an upright position and a lowered position in which the carrier portion is tilted away from the vehicle in response to the vehicle-coupling portion being mounted to the vehicle; and
automatically latch the carrier portion into place in response to the carrier portion being raised by a user from the lowered position to the upright position.

2. The rack according to claim 1, wherein the linkage comprises a base portion fixed to the vehicle-coupling portion, the base portion supporting the carrier portion for pivotal action between the upright position and the lowered position, and a latch portion coupled to the carrier portion, the latch portion comprising a latch formation that is configured to engages with a corresponding formation on the base portion.

3. The rack according to claim 2, wherein the latch portion is pivotally mounted to the carrier portion, and wherein the linkage comprises a resilient biasing member configured to act between the latch portion and the carrier portion to bias the latch portion into a pivotal orientation to maintain engagement between the latch formation and the corresponding formation on the base portion while the carrier is in the upright position.

4. The rack according to claim 3, wherein the latch portion comprises a latch release member projecting therefrom, the latch release member being configured to be manipulated by the user to pivot the latch portion against the force of the resilient biasing member to disengage the latch release member and allow the carrier portion to be lowered.

5. The rack according to claim 4, wherein the latch release member comprises a lever handle that projects rearwardly so as to be operable to the user by hand or foot pressing action.

6. The rack according to claim 2, wherein the base portion comprises a tilt limit member against which a surface of the carrier portion is restable in response to the carrier portion being in the lowered position.

7. The rack according to claim 6, wherein the tilt limit member is moveable or removable by the user so as to permit the carrier portion to be further pivoted beyond the lowered position to a horizontal position.

8. The rack according to claim 2, wherein the latch portion and the base portion comprise corresponding safety formations that are configured to align in response to the carrier being in the upright position and the latch portion being engaged, wherein the rack further comprises a safety member configured to engage with the corresponding safety formations in response to the safety member and the safety formations being aligned, the safety member configured to act to prevent the latch portion from disengaging with the base portion.
